(19) United States
(12) Patent Application Publication
(10) Pub. No.: US 2008/0257118 A1
(43) Pub. Date: Oct. 23, 2008

(54) Sani-Clamp Tool

(76) Inventors: Mark Shaw, Hauppauge, NY (US); Frank Stabile, East Meadow, NY (US)

Correspondence Address: Mark Shaw, PO Box 12131, Hauppauge, NY, 11788, US

(21) Appl. No.: 12/049,895

(22) Filed: Mar. 17, 2008

Related U.S. Application Data
(60) Provisional application No. 60/923,758, filed on Apr. 17, 2007.

(51) Int. Cl. B25B 13/06

(52) U.S. Cl. 81/121.1

(57) ABSTRACT

The sanitary pipe clamping tool described in this document will also be refered to as a “Sani-Clamp Tool”. The Sani-Clamp Tool is a tightening/removal tool, for use specifically with sanitary pipe clamps that join two flanged pipe ends together. The tool is used by placing the reccessed portion of the tool over the winged nut of the pipe clamp, turning clockwise or counterclockwise, allowing the user to tighten or loosen the clamp as desired. The tool is designed for use by itself for proper hand torquing and removal applications, or in conjunction with a drive adaptor, so that a power tool, ratchet, or torquing ratchet may be utilized to maximize efficiency.

### BACKGROUND OF INVENTION

In the Chemical, Cosmetic and Food Processing industries, the common practice of joining two flanged pipe ends together is accomplished by utilizing several different types of pipe clamping devices. The most common device used to fasten the ends securely together, is a multi-piece pipe clamp. In order to obtain a liquid tight seal, a sanitary gasket is often employed between the two pipe ends. The adjoining pipe ends and gasket are compressed together when the user applies clockwise force on the winged nut of the pipe clamp with the thumb and forefinger. Historically, this method of tightening and loosening has been adequate in producing a sufficient seal. However, the installation and removal of multiple clamps places substantial stress, not only on the thumb and forefinger but also on the tendons located in the forearm and elbow. Consequently, a need arises for a tool that ergonomically reduces the stress associated with clamp torquing,with the added benefit of enhancing the speed in which clamp installation and removal occurs.

### DESCRIPTION OF PRIOR ART

As sited in U.S. Pat. No. 4,568,115 the winged nut portion of the clamping apparatus, is in direct relationship to the Sani-Clamp Tool. The Tool is made useful by locating the recessed receptacle over the winged nut, allowing the end user to apply torquing as part of removal or installation process.

### SUMMARY OF THE INVENTION

The above named inventors of the Sani-Clamp Tool have had extensive experience in various manufacturing industries, where liquids distribution occurs. The Sani-Clamp Tool itself allows for injury-free use of sanitary pipe hardware, without cuts or burns, which can result from direct contact with pipes or the pipe clamps themselves. The Sani-Clamp tool can be fabricated from any type of tool grade material, by any machinist or person skilled in the field of parts manufacturing. These materials include, but are not limited to; aluminum, steel and most any, heavy gauge synthetic plastics. The Sani-Clamp Tool can be reproduced to scale, based on the artwork provided.

### DESCRIPTION OF THE DRAWINGS

FIG. 1. Represents the topside view of the tool. It is also labeled North (N), South (S) East (E) West (W), which designates the diametrical quadrant view that will be referred to in later descriptions. The bottom is not viewed in this figure.

FIG. 2. Represents a vertical cross-sectional view of the Southern diametrical quadrant, with east, west, top and bottom labeled respectively.

FIG. 3. Represents a cross-sectional view of the eastern diametric quadrant with the tool lying horizontally. north, south, top and bottom labeled respectively.

FIG. 4. Represents a shaded offset perspective view, highlighting the scale and texture of the tool. It is also used to display the knurled pattern on the outer circumference of the tool.

FIG. 5. Represents an alternate shaded offset perspective view highlighting the scale and texture of the tool.

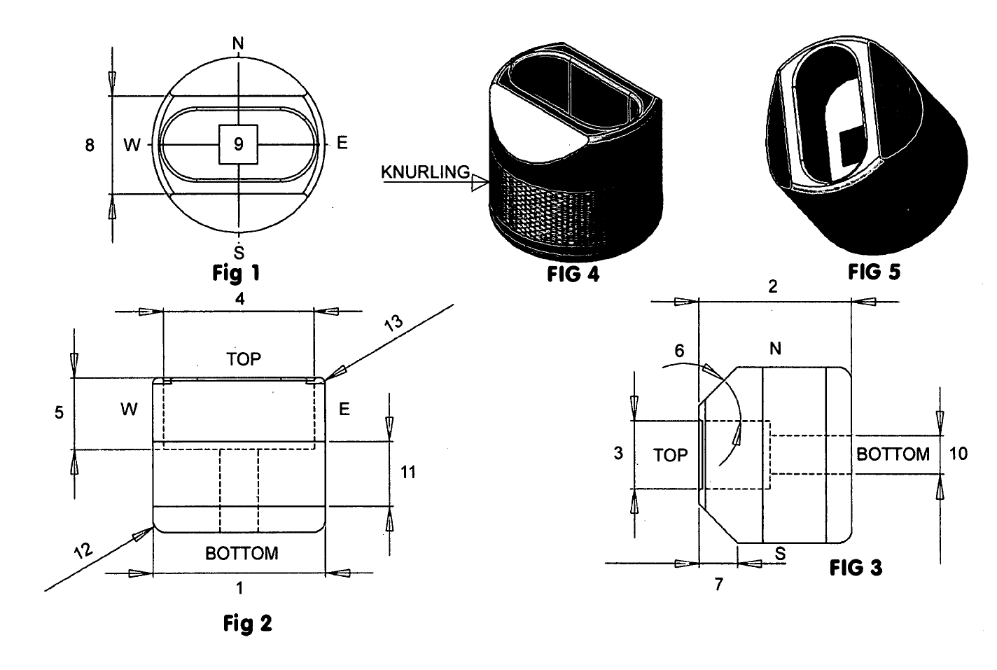

### DESCRIPTION OF THE PREFERRED EMBODIMENT

In referring to the illustrations, the descriptions contained are not intended to limit the scope of the invention, but merely to describe the physically attributes thereof. Other adaptations will inevitably become necessary in the tools development i.e. scale, shape and texture. These descriptions are provided to assist those skilled in the art, to understand the features of its construction.

Reference numeral 1, refers to the length and width of the tool, being in that it is cylindrical the length and width would therefore be the same. Numeral 2 refers to the height of the tool. 3 refers to the width of the oval winged nut receptacle while 4 represents the length and 5 represents the depth of the depression. Numeral 6 depicts the angle of the outer bevel on the N and S quadrant clearly seen in FIG. 3, FIG. 4 and FIG. 5. Numeral 7 represents the height of the bevels. 9 is a representation of the broached square hole which is designated for a torque applying device, not illustrated, such as drive adaptor or ratchet. 10 refers to the position of the broached square hole typically centered in the middle of the tool. 11 is the number that refers to the preferred placement of the knurled pattern allowing the user a substantial grip in which to apply hand torquing. 12 and 13 refer the chamfers located on top and bottom outermost edges of the tool that aids in reducing any sharp corners.

I claim:

1. A cylindrical hand torquing tool for use but not limited to removal and installation of winged nut assemblies typical of sanitary pipe clamps currently used in manufacturing processes, furthermore the tool contains several features conducive to improving the ease in which the end user performs said action, one of which is a beveled plane on the outer edges of the recessed winged nut receptacle to aid in guiding the user to the layout of the receptacle as well reducing the profile allowing the tool to fit in tight areas, additionally a knurled pattern on the outer circumference of the tool allowing the user improved gripping for hand torquing in the removal and installation of winged nut clamps.

2. In addition to claim 1 the mentioned tool will contain a broached square thru hole which will enable the end user to utilize a variety of alternative drive devices, including but not limited to, a ratchet or powered drill driver.

3. In conjunction with claim 1 said tool will be made from light weight easy to maneuver materials including but not limited to aluminum, stainless steel and any type of tool grade manufacturing metals currently used in the tool making industries, as well as any and all types of synthetic plastics and resins or materials used in injection molded products.
